(19) United States
(12) Patent Application Publication
(10) Pub. No.: US 2015/0381775 A1
(43) Pub. Date: Dec. 31, 2015

(54) COMMUNICATION SYSTEM, COMMUNICATION METHOD, CONTROL APPARATUS, CONTROL APPARATUS CONTROL METHOD, AND PROGRAM

(71) Applicant: NEC CORPORATION, Minato-ku, Tokyo (JP)

(72) Inventor: Yuta ASHIDA, Tokyo (JP)

(73) Assignee: NEC CORPORATION, Minato-ku, Tokyo (JP)

(21) Appl. No.: 14/763,116

(22) PCT Filed: Feb. 12, 2014
(86) PCT No.: PCT/JP2014/053171

§ 371 Date: Jul. 23, 2015

(30) Foreign Application Priority Data
Feb. 13, 2013 (JP) 2013-025407

(51) Int. Cl. H04L 29/06

(52) U.S. Cl. CPC H04L 69/22

(57) ABSTRACT

A communication system including: a plurality of communication nodes that process received packets on the basis of a packet handling operation for processing packets; and a control apparatus that sets the packet handling operation in the plurality of communication nodes; wherein, in response to setting a first packet handling operation for changing header information of a packet(s) in a first communication node, the control apparatus sets a second packet handling operation for processing the packet(s) including the changed header information in a second communication node.

### REFERENCE TO RELATED APPLICATION

1. Technical Field

This application is based upon and claims the benefit of the priority of Japanese Patent Application No. 2013-025407 filed on Feb. 13, 2013, the disclosure of which is incorporated herein in its entirety by reference thereto.
The present invention relates to a communication system, a communication method, a control apparatus, a control apparatus control method, and a program. In particular, it relates to: a communication system including a communication node(s) that forwards a packet(s) in accordance with an instruction(s) from a control apparatus(es); a communication method; a control apparatus; a control apparatus control method; and a program.

2. Background

As in non patent literatures (NPLs) 1 and 2, in recent years, a technique referred to as OpenFlow has been proposed. OpenFlow recognizes communications as end-to-end flows and performs path control, failure recovery, load balancing, and optimization on a per-flow basis. An OpenFlow switch serving as a forwarding node has a secure channel for communication with an OpenFlow controller and operates according to a flow table suitably added or rewritten by the OpenFlow controller. In the flow table, a set of the following three is defined for each flow: rules (FlowKey; matching key) against which a packet header is matched; actions (Action) that define at least one processing content; and flow statistical information (Stats).

FIG. 11 illustrates examples of action names and definitions of the contents of the actions disclosed in NPL 2. As can be seen from FIG. 11, OUTPUT is an action for outputting a packet to a specified port (interface), and each of the actions from SET_VLAN_VID to SET_TP_DST is an action for modifying a packet header field.

For example, when an OpenFlow switch receives an initial packet (first packet), the OpenFlow switch searches its flow table for an entry having rules (FlowKey) that match header information of the received packet. As a result of the search, if the OpenFlow switch finds an entry that matches the received packet, the OpenFlow switch processes the received packet on the basis of the processing content(s) written in the action field of the entry. If, as a result of the search, the OpenFlow switch does not find an entry that matches the received packet, the OpenFlow switch forwards the received packet to the OpenFlow controller via the corresponding secure channel, to request the OpenFlow controller to determine a packet forwarding path on the basis of a source and a destination of the received packet. When receiving the request, the OpenFlow controller calculates and transmits a packet forwarding path to the OpenFlow switch. The OpenFlow switch receives a flow entry that realizes the packet forwarding path from the OpenFlow controller and updates its own flow table.

As described above, an individual OpenFlow switch determines a packet processing method on the basis of a flow entry set by the OpenFlow controller. In this way, in OpenFlow, the OpenFlow controller controls OpenFlow switches and realizes control of packets as control of flows defined by matching rules (matching conditions).

### CITATION LIST

### Non Patent Literature

NPL 1: Nick McKeown, and seven others, “OpenFlow: Enabling Innovation in Campus Networks,” [online], [searched on Feb. 1, 2013], Internet
<URL:http://www. openflowswitch. org//documents/openflow-wp-latest. pdf>
NPL 2: “OpenFlow Switch Specification” Version 1.0.0 (Wire Protocol 0x01), [searched on Feb. 1, 2013], Internet
<URL:http ://www.openflowswitch.org/documents/openflow-spec-v1.0.0.pdf>

### SUMMARY

### Technical Problem

The disclosure of each literature in the above citation list is incorporated herein by reference thereto. The following analysis has been given by the present inventors.

With the OpenFlow disclosed in NPLs 1 and 2, a flow entry that is newly set in an OpenFlow switch could conflict with a flow entry that has already been set in the OpenFlow switch. More specifically, the matching rules included in a flow entry that is newly set could overlap with those included in a flow entry that has already been set. In such case, the OpenFlow switch cannot determine which flow entry needs to be used to process a received packet. For example, the OpenFlow switch could process a received packet on the basis of a flow entry for processing other packets that belong to a different flow, instead of a flow entry for processing the received packet. Namely, in an OpenFlow switch disclosed in NPLs 1 and 2, a flow entry inappropriate for a received packet could be hit, and unintended processing could be performed.

It is an object of the present invention to prevent a flow entry(ies) inappropriate for a received packet(s) from being hit and to prevent unintended processing from being performed.

### Solution to Problem

According to a first aspect of the present invention, there is provided a communication system, comprising: a plurality of communication nodes that process received packets on the basis of a packet handling operation for processing packets; and a control apparatus that sets the packet handling operation in the plurality of communication nodes; wherein, in response to setting a first packet handling operation for changing header information of a packet(s) in a first communication node, the control apparatus sets a second packet handling operation for processing the packet(s) including the changed header information in a second communication node.

According to a second aspect of the present invention, there is provided a communication system, comprising: a plurality of networks that include a plurality of control apparatuses that set packet handling operations for processing packets in a plurality of communication nodes; wherein a first control apparatus included in a first network sets a first packet handling operation for changing header information of a packet(s) in a first communication node included in the first network; and wherein in response to that the first control apparatus sets the first packet handling operation, a second control apparatus included in a second network sets a second packet handling operation for processing the packet(s) including the changed header information in a second communication node included in the second network.

According to a third aspect of the present invention, there is provided a communication method for a communication system including a plurality of communication nodes that process received packets on the basis of a packet handling operation for processing packets, the communication method comprising steps of: setting a first packet handling operation for changing header information of a packet(s) in a first communication node; and setting a second packet handling operation for processing the packet(s) including the changed header information in a second communication node in response to that the first packet handling operation is set.

This method is associated with a certain machine, namely, with a communication system that includes a plurality of communication nodes.

According to a fourth aspect of the present invention, there is provided a control apparatus, controlling a first network in which a packet(s) is forwarded from a first communication node to a second communication node; wherein the control apparatus sets a first packet handling operation for causing the first communication node to rewrite header information of a packet(s) received thereby in the first communication node; and wherein the control apparatus sets a second packet handling operation for causing the second communication node to process the packet(s) including the rewritten header information in the second communication node.

According to a fifth aspect of the present invention, there is provided a control apparatus control method for controlling a control apparatus that controls a first network in which a packet(s) is forwarded from a first communication node to a second communication node, the control apparatus control method comprising steps of: setting a first packet handling operation for causing the first communication node to rewrite header information of a packet(s) received thereby in the first communication node; and setting a second packet handling operation for causing the second communication node to process the packet(s) including the rewritten header information in the second communication node.

This method is associated with a certain machine, namely, with a control apparatus which controls a network that includes a plurality of communication nodes.

According to a sixth aspect of the present invention, there is provided a program, causing a computer that controls a control apparatus that controls a first network in which a packet(s) is forwarded from a first communication node to a second communication node to perform processing for: setting a first packet handling operation for causing the first communication node to rewrite header information of a packet(s) received thereby in the first communication node; and setting a second packet handling operation for causing the second communication node to process the packet(s) including the rewritten header information in the second communication node.

This program can be recorded in a computer-readable storage medium. The storage medium may be a non-transient storage medium such as a semiconductor memory, a hard disk, a magnetic recording medium, or an optical recording medium. The present invention can be embodied as a computer program product.

### Advantageous Effects of Invention

According to the individual aspects of the present invention, there are provided a communication system, a communication method, a control apparatus, a control apparatus control method, and a program that contribute to preventing a flow entry(ies) inappropriate for a received packet(s) from being hit and to prevent unintended processing from being performed.

### BRIEF DESCRIPTION OF DRAWINGS

FIG. 1 illustrates an outline of an exemplary embodiment.

FIG. 2 illustrates an exemplary configuration of a communication system according to a first exemplary embodiment.

FIG. 3 illustrates an exemplary internal configuration of a control apparatus 20.

FIGS. 4A and 4B illustrate examples of packet handling operations that are set in communication nodes 10-1 and 10-2.

FIG. 5 illustrates an exemplary operation of the control apparatus 20 according to the first exemplary embodiment.

FIGS. 6A and 6B illustrate exemplary packet handling operations that are set in the communication node 10-1 and 10-2.

FIG. 7 illustrates an exemplary configuration of a communication system according to a third exemplary embodiment.

FIG. 8 illustrates an exemplary internal configuration of a control apparatus 40.

FIG. 9 is a sequence diagram illustrating an exemplary operation of the communication system according to the third exemplary embodiment.

FIGS. 10A, 10B and 10C illustrate exemplary packet handling operations that are set in communication nodes 10-3 to 10-5.

FIG. 11 illustrates examples of action names and definitions of the contents of the actions disclosed in NPL 2.

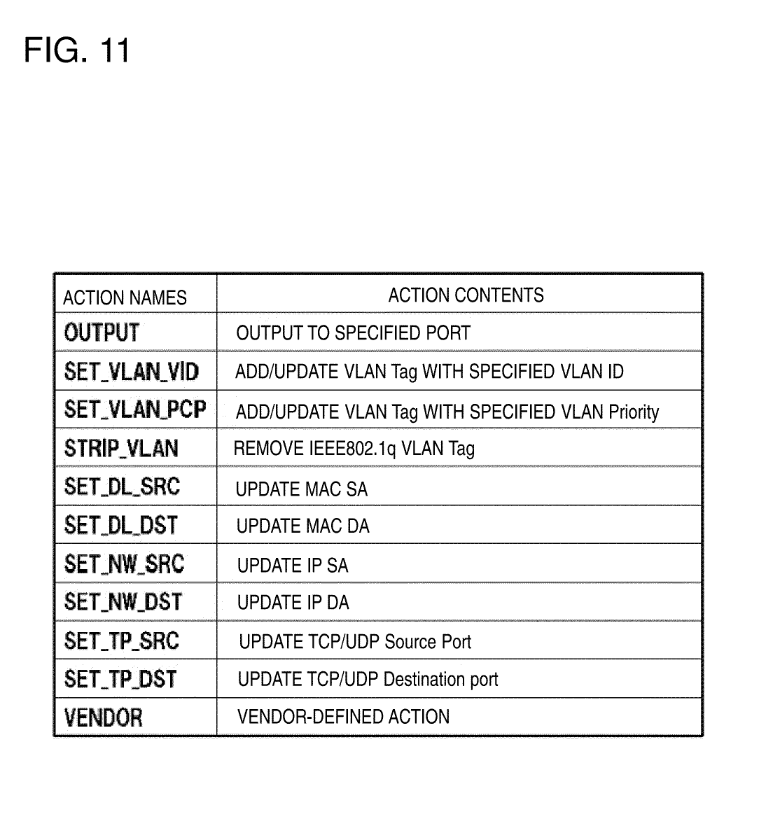

### DESCRIPTION OF EMBODIMENTS

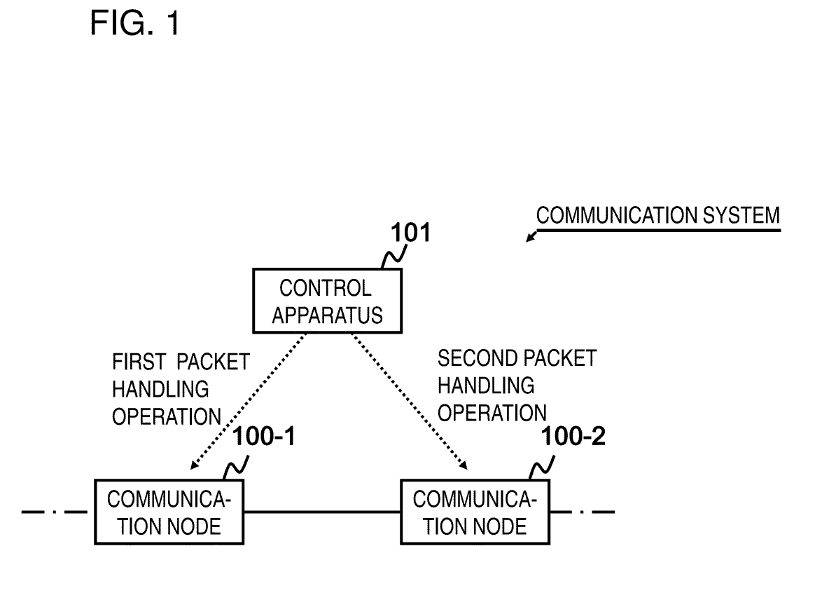

First, an outline of an exemplary embodiment will be described with reference to FIG. 1. In the following outline, various components are denoted by reference characters for the sake of convenience. Namely, the following reference characters are merely used as examples to facilitate understanding of the present invention. The description of the outline does not to intend to set any limitations.

As described above, the above OpenFlow disclosed in NPLs 1 and 2 does not ensure consistent flow control in a network including a control apparatus and a plurality of communication nodes. The above OpenFlow could cause a conflict between a set of matching rules that are newly set in a communication node and a set of matching rules that have already been set in the communication node. Namely, traffics that need to be handled as different flows could be handled as the same traffic, and packets that belong to a traffic could be forwarded to a destination different from an intended forwarding destination. Thus, there is demanded a communication system or the like that maintains consistency of flow control from a traffic occurrence point to a traffic reception point in a wide area network in which a control apparatus controls at least one communication node.

Thus, for example, a communication system illustrated in FIG. 1 is provided. The communication system illustrated in FIG. 1 includes a plurality of communication nodes (for example, a first communication node 100-1 and a second communication node 100-2) and a control apparatus 101 that controls the plurality of communication nodes. Each of the plurality of communication nodes processes received packets on the basis of packet handling operations for processing packets. By setting these packet handling operations in the plurality of communication nodes, the control apparatus 101 controls a network including the plurality of communication nodes. In addition, in response to setting a first packet handling operation for changing header information of a packet(s) in a first communication node 100-1, the control apparatus 101 sets a second packet handling operation for processing the packet(s) including the changed header information in a second communication node 100-2.

If there is a possibility that an existing flow that has already been set in the network could be mixed with a flow that is newly set, the control apparatus 101 sets a packet handling operation for avoiding a collision of these flows in the first communication node 100-1. More specifically, the control apparatus 101 sets a packet handling operation for causing the first communication node 100-1 to rewrite header information of a packet(s) received thereby in the first communication node 100-1. The communication nodes 100-1 and 100-2 use the packet header information as information for identifying the packet(s). Thus, by causing the first communication node 100-1 to rewrite the packet header information, the packets that belong to an existing flow and the packets that belong to a newly set flow can be distinguished from each other. As a result, since the communication node 100-2 can accurately identify the packets that belong to an individual one of the flows, a mixture of flows is prevented. In addition, in the above OpenFlow disclosed in NPLs 1 and 2, when header information about a packet is changed, for example, a switch recognizes that the packet before the change of the header information and the packet after the change of the header information belong to different flows. Thus, the control apparatus 101 sets the second packet handling operation in the second communication node 100-2 so that the second communication node 100-2 can process the packet(s) whose header information has been rewritten by the first communication node 100-1. As a result, the communication system illustrated in FIG. 1 can maintain consistency of flow control from a traffic occurrence point to a traffic reception point.

Hereinafter, specific embodiments will be described in detail with reference to the drawings.

### First Exemplary Embodiment

A first exemplary embodiment will be described in detail with reference to drawings.

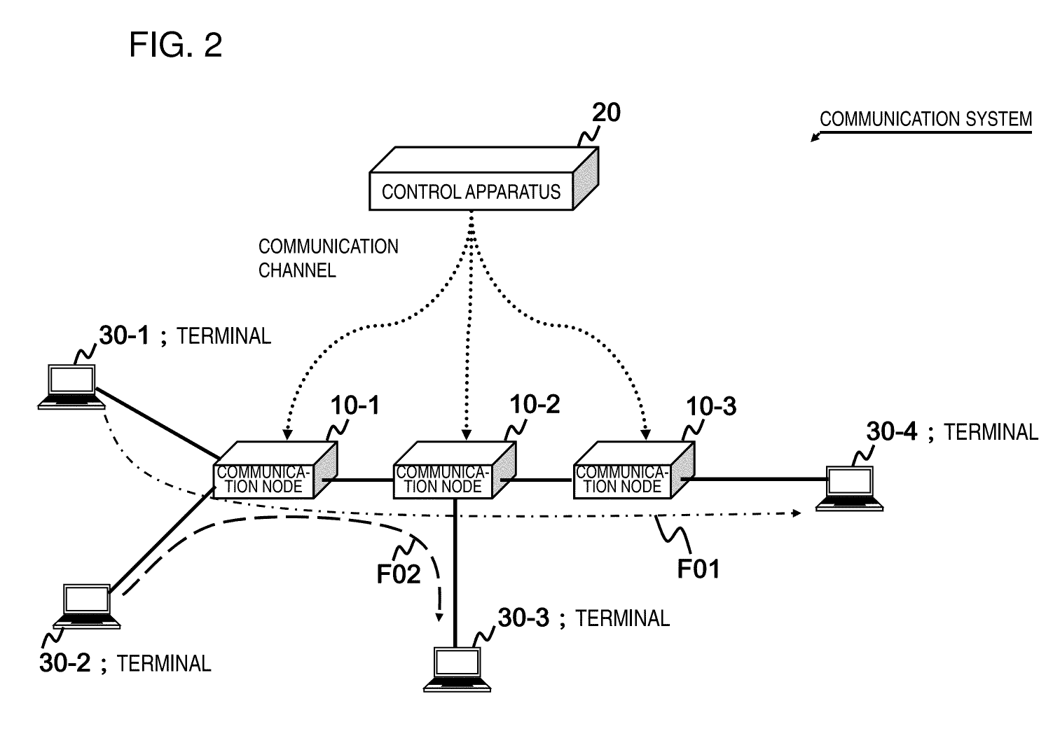

FIG. 2 illustrates an exemplary configuration of a communication system according to the present exemplary embodiment.

As illustrated in FIG. 2, the communication system includes communication nodes 10-1 to 10-3 that realize connection in a network, a control apparatus 20 that controls the network including the communication nodes 10-1 to 10-3, and terminals 30-1 to 30-4. For example, the control apparatus 20 corresponds to an OpenFlow controller, and the communication nodes 10-1 to 10-3 correspond to OpenFlow switches. In the following description, each of the communication nodes 10-1 to 10-3 will be referred to as a “communication node 10” unless these nodes need to be distinguished from each other.

Each of the communication nodes 10 processes received packets on the basis of processing rules (i.e., packet handling rules, termed herein as “packet handling operations”) including matching rules against which header information of the packets is matched.

The control apparatus 20 is connected to the communication nodes 10-1 to 10-3 via control communication channels indicated by dashed lines, respectively, in FIG. 2. In addition, the communication node 10-1 is connected to the terminals 30-1 and 30-2, and the communication nodes 10-2 and 10-3 are connected to the terminals 30-3 and terminal 30-4, respectively. The communication system illustrated in FIG. 2 is only an example. For example, the number of communication nodes and the connection among the communication nodes are not limited to those in FIG. 2. For example, the communication system may include any number of communication nodes.

The control apparatus 20 performs flow control, in response to a query from a communication node 10 or on the basis of change of a topology of a control target network of the control apparatus 20. Alternatively, the control apparatus 20 may perform flow control in accordance with instructions from a user who manages the network, change of a status such as registration of a new host, or a path setting command from an external apparatus, for example.

The control apparatus 20 performs flow control on the communication nodes 10 by setting packet identification conditions (matching rules; matching key) for identifying a flow and a packet processing method (action) that defines a processing content of the packets that match the packet identification conditions in the communication nodes 10. The packet identification conditions and the packet processing method may be calculated by the control apparatus 20 or may be supplied from the outside.

Next, an operation of the communication system according to the present exemplary embodiment will be described. The following description will be made assuming that the terminal 30-1 transmits packets to the terminal 30-4.

When the terminal 30-1 transmits packets to the terminal 30-4, as indicated by a dashed-dotted line in FIG. 2, a packet forwarding path that extends through the communication nodes 10-1, 10-2, and 10-3 is used. Thus, the control apparatus 20 needs to set packet handling operations for forwarding packets in the communication nodes 10-1 to 10-3. The control apparatus 20 sets a packet handling operation in the communication node 10-1, the packet handling operation indicating forwarding packets to the communication node 10-2 and rewriting packet header information.

Examples of the packet header field rewritten by the communication node 10-1 include the source MAC address, the destination MAC address, the source IP address, the destination IP address, and a port number used by the transport layer protocol. The communication node 10-1 may rewrite a field(s) other than the above field.

If the control apparatus 20 sets a packet handling operation in the communication node 10-2 without regard to the packet handling operation that is set in the communication node 10-1, a problem is caused. More specifically, in such case, the communication node 10-2 cannot accommodate the packet(s) whose header information has been rewritten by the communication node 10-1 and the packet(s) whose header information has not been rewritten to the same flow.

Thus, the control apparatus 20 calculates the packet identification conditions that are set in the communication node 10-2 and sets the calculated packet identification conditions in the communication node 10-2 as a packet handling operation so that the header information rewritten by the communication node 10-1 matches in the communication node 10-2. Processing for changing the header information rewritten by the communication node 10-1 back to its initial value may be added in the packet handling operation that is set in the communication node 10-2.

In addition, if the control apparatus 20 causes the communication node 10-2 to restore the header information, the control apparatus 20 calculates packet identification conditions on the basis of the restored header information and sets a packet handling operation for forwarding packets to the terminal 30-4 in the communication node 10-3. Alternatively, if the control apparatus 20 does not cause the communication node 10-2 to restore the header information, the control apparatus 20 calculates and sets packet identification conditions and a packet processing method in the communication node 10-3 as a packet handling operation, on the basis of the header information rewritten by the communication node 10-1.

By setting the communication nodes 10-1 to 10-3 as described above, the header information is changed to a different value by an arbitrary node in the network temporarily or continuously during forwarding in the network. As a result, even in a situation where packet identification conditions match and a mixture of flows could occur, an individual communication node can uniquely identify each flow and can accommodate packets into accurate flows.

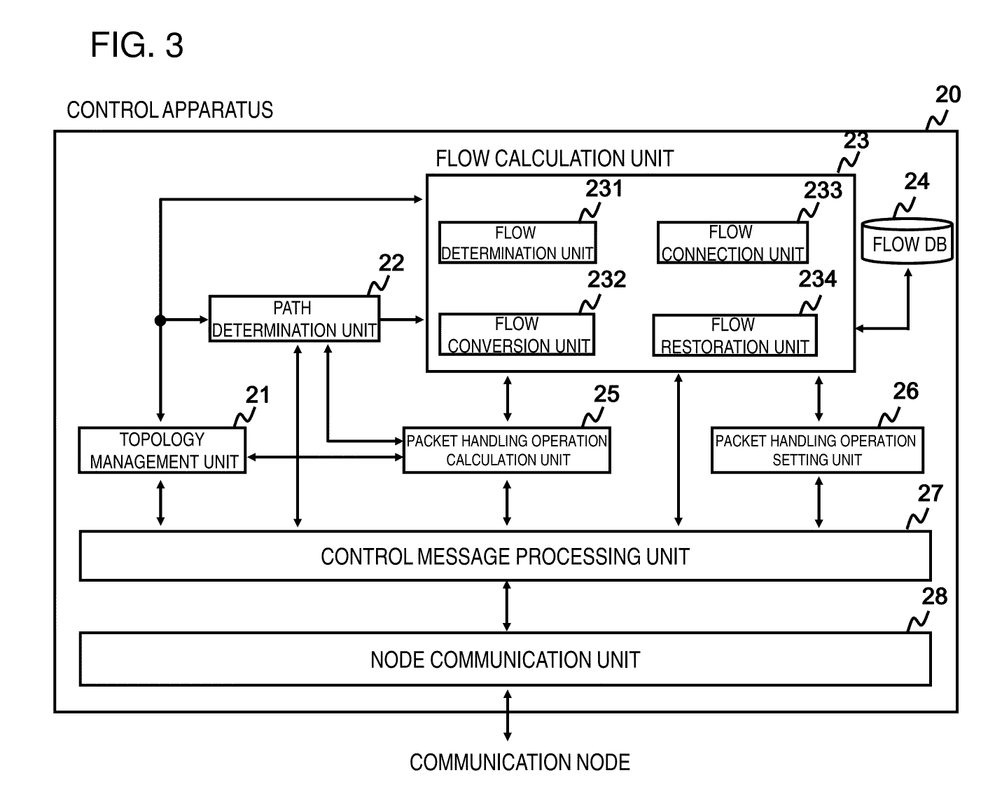

FIG. 3 illustrates an exemplary internal configuration of the control apparatus 20.

As illustrated in FIG. 3, the control apparatus 20 includes a topology management unit 21, a path determination unit 22, a flow calculation unit 23, a flow database (DB) 24, a packet handling operation calculation unit 25, a packet handling operation setting unit 26, a control message processing unit 27, and a node communication unit 28. Each unit included in the control apparatus 20 can be realized by a computer program that causes a computer included in the control apparatus 20 to use its hardware and perform processing described in detail below.

The topology management unit 21 is a means for collecting network topology information and managing the collected topology information.

The path determination unit 22 is a means for determining a path(s) used for packet forwarding. The path determination unit 22 determines a packet forwarding path(s) by referring to a destination IP address and the like written in the packet header. The control apparatus 20 may receive a packet forwarding path(s) from the outside, instead of causing the path determination unit 22 to calculate the packet forwarding path(s).

The flow calculation unit 23 is a means for calculating and managing flows that need to be controlled in a control target network of the control apparatus 20. The flow calculation unit 23 will be described in detail below.

The flow DB 24 can be accessed by the flow calculation unit 23 and store information relating to the flows that have already been set by the control apparatus 20 in the communication nodes 10.

The packet handling operation calculation unit 25 breaks down the packet forwarding path(s) determined by the path determination unit 22 and calculates packet handling operations (packet identification conditions and packet processing methods) that need to be set in the communication nodes 10. The packet handling operation calculation unit 25 outputs the calculated packet handling operations to the flow calculation unit 23.

The packet handling operation setting unit 26 is a means for requesting the control message processing unit 27 to set the packet handling operations in the communication nodes 10.

The control message processing unit 27 is a means for converting a control content that is set in a communication node 10 into a control message or analyzing and processing a control message from a communication node 10.

The node communication unit 28 is a means for realizing communication with the communication nodes 10.

The flow calculation unit 23 includes a flow determination unit 231, a flow conversion unit 232, a flow connection unit 233, and a flow restoration unit 234.

The flow determination unit 231 is a means for determining whether a set of packet identification conditions calculated by the packet handling operation calculation unit 25 collide (overlap) with a set of packet identification conditions previously set in any one of the other communication nodes 10 (whether a mixture of flows occurs).

When a new flow is set, if the flow determination unit 231 determines that a collision of packet identification conditions occurs, the flow conversion unit 232 determines a communication node that rewrites header information and a value that is rewritten in the header information. Hereinafter, a packet processing method obtained as a result of the processing by the flow conversion unit 232 will be referred to as a flow conversion rule.

The flow connection unit 233 is a means for calculating packet identification conditions so that a packet(s) whose header information has been rewritten by a communication node included in a packet forwarding path can be forwarded by the next forwarding communication node. Hereinafter, a packet identification condition obtained as a result of the processing by the flow connection unit 233 will be referred to as a flow connection rule.

The flow restoration unit 234 is a means for calculating a packet processing method for causing an endpoint on a packet forwarding path, a communication node in which a flow connection rule is set, or another arbitrary communication node to change the rewritten header information back to its initial value. Hereinafter, a packet processing method obtained as a result of the processing by the flow restoration unit 234 will be referred to as a flow restoration rule.

Next, an operation of the communication system according to the present exemplary embodiment will be described.

Hereinafter, the following operation of the communication system will be described on the basis of an example where a flow for forwarding a certain traffic from the terminal 30-1 to the terminal 30-4 in FIG. 2 has already been set and a flow for forwarding a traffic from the terminal 30-2 to the terminal 30-3, the flow having a feature similar to that of the certain traffic, is newly set. In addition, the flow from the terminal 30-1 to the terminal 30-4 will be referred to as a flow F01, and the flow from the terminal 30-2 to the terminal 30-3 will be referred to as a flow F02.

In FIG. 2, the packet forwarding path used for forwarding packets from the terminal 30-1 to the terminal 30-4 includes the communication nodes 10-1 to 10-3, as described above. In addition, packets received by the communication node 10-3 are outputted to an interface connected to the terminal 30-4. The packet forwarding path used for forwarding packets from the terminal 30-2 to the terminal 30-3 includes the communication nodes 10-1 and 10-2. Packets received by the communication node 10-2 are outputted to an interface connected to the terminal 30-3. The flows F01 and F02 share some communication nodes included in these two packet forwarding paths. Namely, the communication nodes 10-1 and 10-2 are used by the two packet forwarding paths.

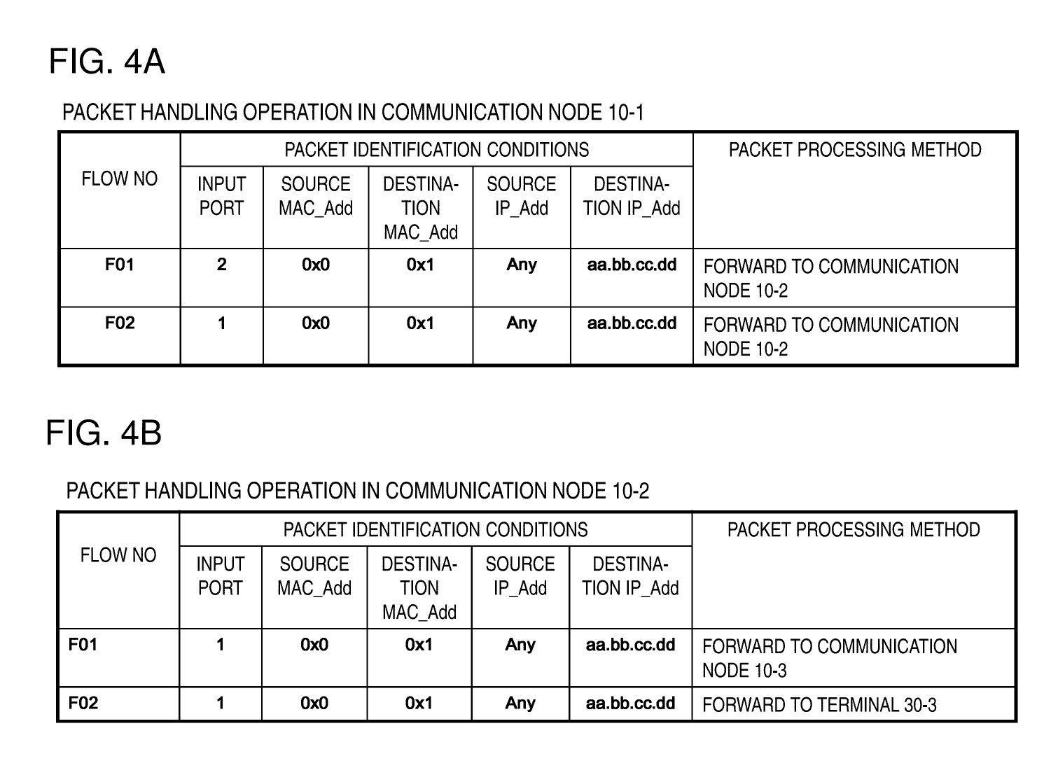

FIGS. 4A and 4B illustrate examples of packet handling operations that can be set in the communication nodes 10-1 and 10-2. However, the packet handling operations in FIGS. 4A and 4B cause a mixture of flows. Hereinafter, why a mixture of flows is caused will be described.

In the communication node 10-1, since the packets that belong to the flow F01 and the packets that belong to the flow F02 are inputted via the respective interfaces (namely, since the traffic occurrence points are different), the communication node 10-1 can identify the flows F01 and F02 by using information about the interfaces that have received the respective groups of packets (see FIG. 4A). However, there are cases in which all the packet identification conditions including the packet reception interfaces are the same in the communication node 10-2 (see FIG. 4B). In such case, since the communication node 10-2 cannot distinguish the flows F01 and F02, received packets are mixed with either one of the flows in the communication node 10-2.

Thus, to avoid a mixture of flows, the control apparatus 20 sets a packet processing method (flow conversion rule) for rewriting header information in the communication node 10-1, which is a packet forwarding source that forwards the relevant packets to the communication node 10-2 on the packet forwarding path.

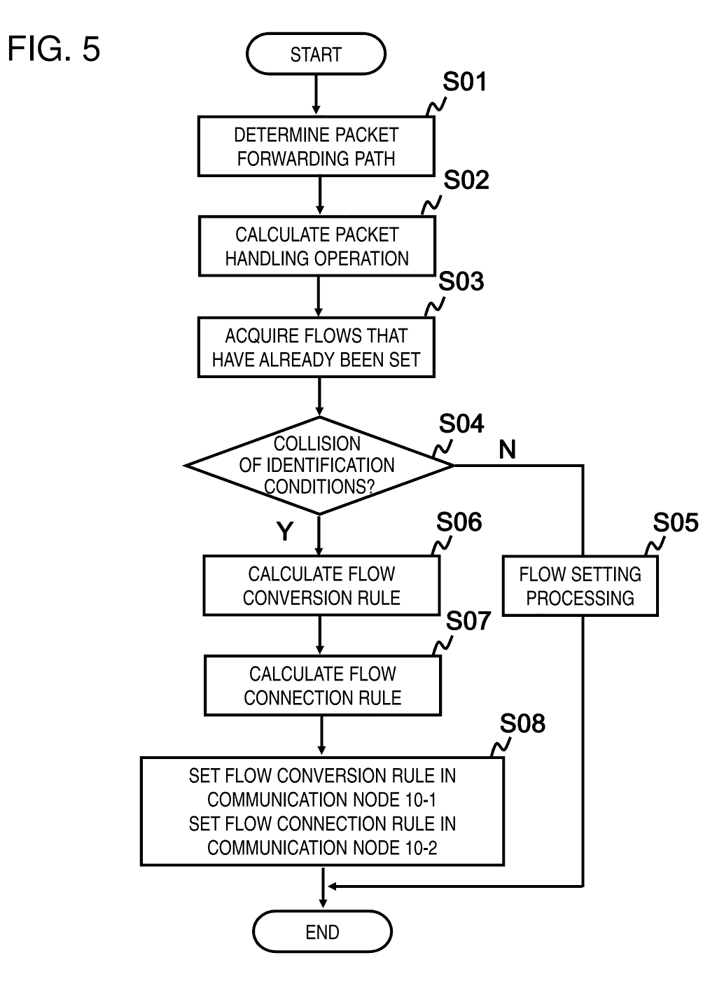

FIG. 5 illustrates an exemplary operation of the control apparatus 20 according to the present exemplary embodiment.

In step S01, when requested by a communication node 10 to determine a packet forwarding path, the path determination unit 22 determines a packet forwarding path. In this example, the path determination unit 22 receives a received packet from the communication node 10-1 and determines a packet forwarding path (flow F02) using the communication nodes 10-1 and 10-2.

In step S02, the packet handling operation calculation unit 25 calculates packet handling operations (packet identification conditions and packet processing methods) that need to be set in the communication nodes included in the packet forwarding path determined in the previous step. In this example, the packet handling operation calculation unit 25 calculates a packet handling operation for each of the communication nodes 10-1 and 10-2.

In step S03, the flow determination unit 231 acquires, from the flow DB 24, information about the flows that have already been set in the control target network of the control apparatus 20.

In step S04, the flow determination unit 231 compares the packet identification conditions that have been calculated by the packet handling operation calculation unit 25 and that are set in the relevant communication nodes with the packet identification conditions that have already been set in the communication nodes obtained from the information about the flows that have already been set, the information having been acquired in step S03. In addition, the flow determination unit 231 determines whether a collision of packet identification conditions occurs. More specifically, if the packet identification conditions calculated by the packet handling operation calculation unit 25 match any set of previously-set packet identification conditions, the flow determination unit 231 determines that a collision of packet identification conditions occurs.

For example, as illustrated in FIG. 4A, in the communication node 10-1, since the determination conditions about the input port are different, the flow determination unit 231 determines that the packet identification conditions for the flow F01 are different from those for the flow F02. However, as illustrated in FIG. 4B, in the communication node 10-2, since the packet identification conditions for the flow F01 match those for the flow F02, the flow determination unit 231 determines that a collision of the packet identification conditions occurs.

If such collision of packet identification conditions does not occur (No in step S04), the control apparatus 20 sets the packet handling operations calculated by the packet handling operation calculation unit 25 in the communication nodes 10 via the packet handling operation setting unit 26 and the control message processing unit 27 (step S05).

If a collision of packet identification conditions occurs (Yes in step S04), the control apparatus 20 performs processing in steps S06 to S08.

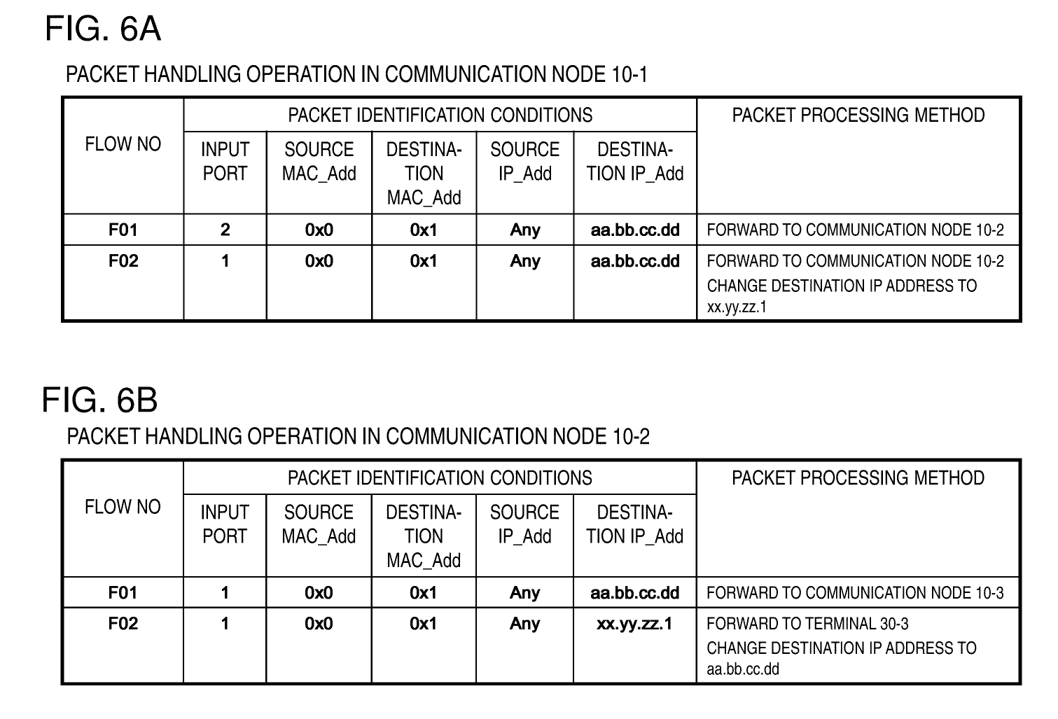

In step S06, the flow conversion unit 232 calculates packet handling operations (flow conversion rule) that avoid a collision of packet identification conditions. FIGS. 6A and 6B illustrate exemplary packet handling operations that are set in the communication nodes 10-1 and 10-2. If the packet handling operations calculated by the packet handling operation calculation unit 25 are set in the communication nodes 10-1 and 10-2, a collision of packet identification conditions occurs and a mixture of flows occurs in the communication node 10-2, as described above.

Thus, the flow conversion unit 232 determines a communication node that forwards the relevant packets to the communication node in which the collision of packet identification conditions occurs. In this example, the flow conversion unit 232 determines the communication node 10-1 as such communication node. In addition, the flow conversion unit 232 calculates a packet processing method for rewriting at least a portion of the header of each packet that belongs to the newly set flow.

For example, as illustrated in FIG. 6A, for forwarding the packets that belong to the flow F02, processing for rewriting the destination IP address is calculated as the packet processing method. The header information that is rewritten is not limited to the destination IP address. Another field may be rewritten or a plurality of fields may be rewritten. Namely, an arbitrary field(s) may be rewritten, as long as a set of packet identification conditions obtained from rewriting of the header information and a set of packet identification conditions used in a previously set flow do not collide with each other.

In step S07, the flow connection unit 233 calculates packet identification conditions (flow connection rule) that are set in a communication node on the basis of the rewritten header information. For example, as illustrated in FIG. 6A, the communication node 10-1 rewrites the header information of each packet that belongs to the flow F02. More specifically, the field of the destination IP address of each packet that belongs to the flow F02 is rewritten to xx.yy.zz.1.

The flow connection unit 233 calculates the packet identification conditions that are set in a communication node that receives the packets whose header information has been rewritten on the basis of the rewritten header information. More specifically, as illustrated in FIG. 6B, the destination IP address in the packet identification conditions for the flow F02 in the communication node 10-2 is calculated to be xx.yy.zz.1.

In step S08, by using the packet handling operation setting unit 26 and the control message processing unit 27, the control apparatus 20 sets the packet handling operation including the flow conversion rule and the packet handling operation including the flow connection rule in the respective communication nodes 10. More specifically, in the communication node 10-1, the control apparatus 20 sets a packet handling operation for forwarding the packets that need to belong to the flow F02 to the communication node 10-2 and rewriting the destination IP address of the packets.

In addition, in the communication node 10-2, the control apparatus 20 sets a packet handling operation including a packet identification condition corresponding to the header information rewritten by the communication node 10-1 and indicating forwarding the packets that belong to the flow F02 to the terminal 30-3.

Processing for restoring the header information rewritten by the communication node 10-1 may be performed by an arbitrary communication node any time after the collision of packet identification conditions is avoided. For example, as illustrated in FIG. 6B, the communication node 10-2 may perform packet restoration. Namely, in the example in FIG. 6B, a flow connection rule and a flow restoration rule are set in the communication node 10-2.

In step S08 in FIG. 5, the setting of the packet handling operation in the communication node 10-1 and the setting of the packet handling operation in communication node 10-2 are performed in parallel. However, the flow connection rule may be set before the flow conversion rule is set. In this way, it is possible to prevent the communication node 10-1 from converting the flow (rewriting the header information) first. Thus, the number of queries from the communication node 10-2 to the control apparatus 20 can be reduced.

In addition, in FIG. 6B, while the flow restoration rule is set in the communication node 10-2, if the terminal 30-3 can receive the packets whose header information has been rewritten without problem (does not drop such packets), restoration of the header information is not necessary.

The communication system according to the present exemplary embodiment is beneficial when a plurality of networks are virtually established on a common communication infrastructure and service environments are individually established on virtual networks, particularly when a cloud service such as an IaaS (Infrastructure as a service) or a NaaS (network as a service) is provided.

As described above, with the control apparatus 20 according to the present exemplary embodiment, even in a situation where packets that belong to a flow and packets that belong to another flow could cause a mixture of flows because of similar features thereof, each of the flows can accurately be identified. As a result, a mixture of flows can be prevented in the communication system according to the present exemplary embodiment.

### Second Exemplary Embodiment

Next, a second exemplary embodiment will be described in detail with reference to the drawings.

A control apparatus 20a according to the present exemplary embodiment has the same configuration as that of the control apparatus 20 according to the first exemplary embodiment. Thus, regarding the control apparatus 20a, the description corresponding to FIG. 3 will be omitted.

The control apparatus 20a differs from the control apparatus 20 in how the flow calculation unit 23 calculates packet identification conditions. When the control apparatus 20a according to the present exemplary embodiment calculates a set of packet identification conditions that does not conflict with a set of previously set packet identification conditions, the control apparatus 20a defines an identifier that can uniquely identify a flow, thereby simplifying the calculation processing.

When setting a flow in a network, the control apparatus 20a allocates a flow identifier that can uniquely identify the flow to the flow. This flow identifier may be a number that is based on the order in which flows are generated or may be a hash value calculated from a packet identification condition (packet header) corresponding to the flow or other information. Namely, as long as the identifier is a value that can uniquely identify the flow, the identifier can be determined by an arbitrary method.

The control apparatus 20a uses this flow identifier as a packet header change rule when calculating a flow conversion rule and a flow connection rule described in the first exemplary embodiment. Namely, when the control apparatus 20a sets a new flow in a network, if the control apparatus 20a determines that a collision of packet identification conditions occur between the newly set flow and a previously set flow, the control apparatus 20a sets a packet handling operation for writing a flow identifier in a packet header field as a flow conversion rule.

In addition, the control apparatus 20a sets a packet handling operation including the flow identifier as a packet identification condition as a flow connection rule in the next forwarding destination node of the communication node in which the flow conversion rule has been set. Such flow identifiers may originally be set when the network operation is started first, not just when the control apparatus 20a determines that a collision of packet identification conditions occurs between a newly set flow and an existing flow.

As described above, the control apparatus 20a according to the present exemplary embodiment identifies a flow by using a flow identifier, instead of calculating packet identification conditions. As a result, the calculation of a flow conversion rule and a flow connection rule can be simplified.

### Third Exemplary Embodiment

Next, a third exemplary embodiment will be described in detail with reference to the drawings.

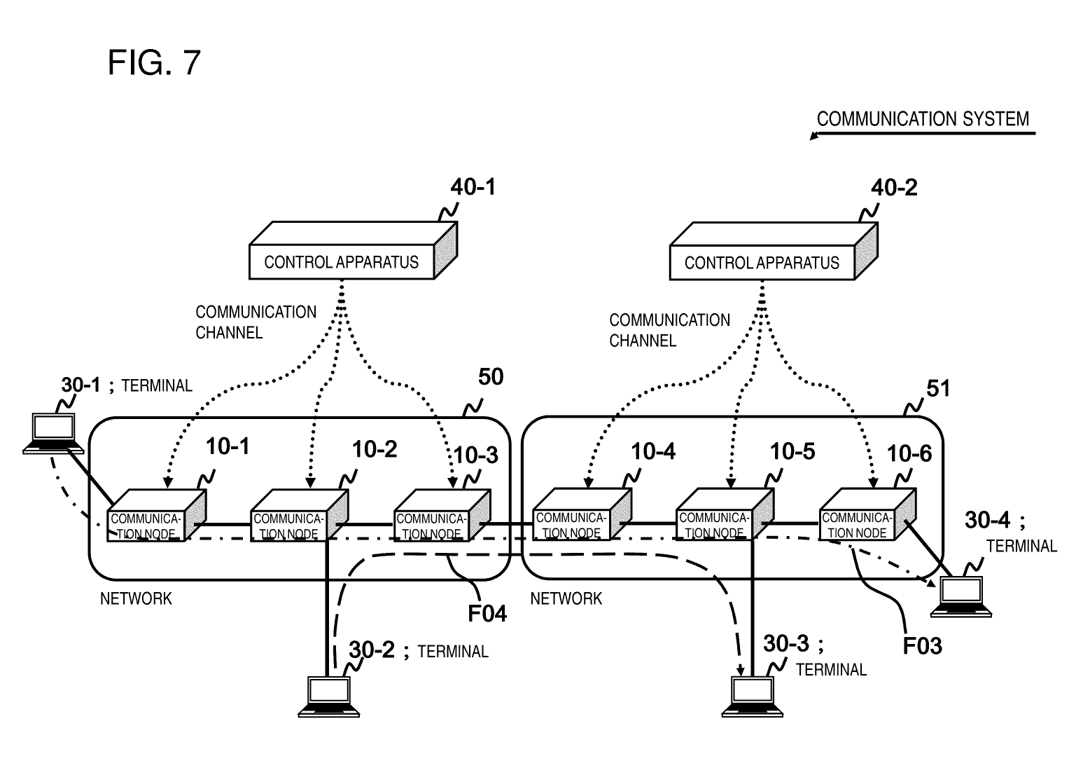

FIG. 7 illustrates an exemplary configuration of a communication system according to the present exemplary embodiment.

As illustrated in FIG. 7, the communication system includes a network 50 which includes communication nodes 10-1 to 10-3 and a control apparatus 40-1 that controls these communication nodes and a network 51 which includes communication nodes 10-4 to 10-6 and a control apparatus 40-2 that controls these communication nodes. The control apparatus 40-1 is connected to the communication nodes 10-1 to 10-3 by control communication channels indicated by dotted lines in FIG. 7, respectively. Likewise, the control apparatus 40-2 is connected to the communication nodes 10-4 to 10-6 by control communication channels indicated by dotted lines in FIG. 7, respectively. In the following description, each of the control apparatuses 40-1 and 40-2 will be referred to as a “control apparatus 40” unless these control apparatuses need to be distinguished from each other. Likewise, each of the communication nodes 10-1 to 10-6 will be referred to as a “communication node 10” unless these nodes need to be distinguished from each other.

The communication nodes 10-3 and 10-4 connect the networks by a link. In addition, the communication nodes 10-1, 10-2, 10-5, and 10-6 are connected to terminals 30-1 to 30-4, respectively. The communication system illustrated in FIG. 7 is only an example. For example, the number of communication nodes and the connection among the communication nodes are not limited to those in FIG. 7. For example, the communication system may include any number of communication nodes.

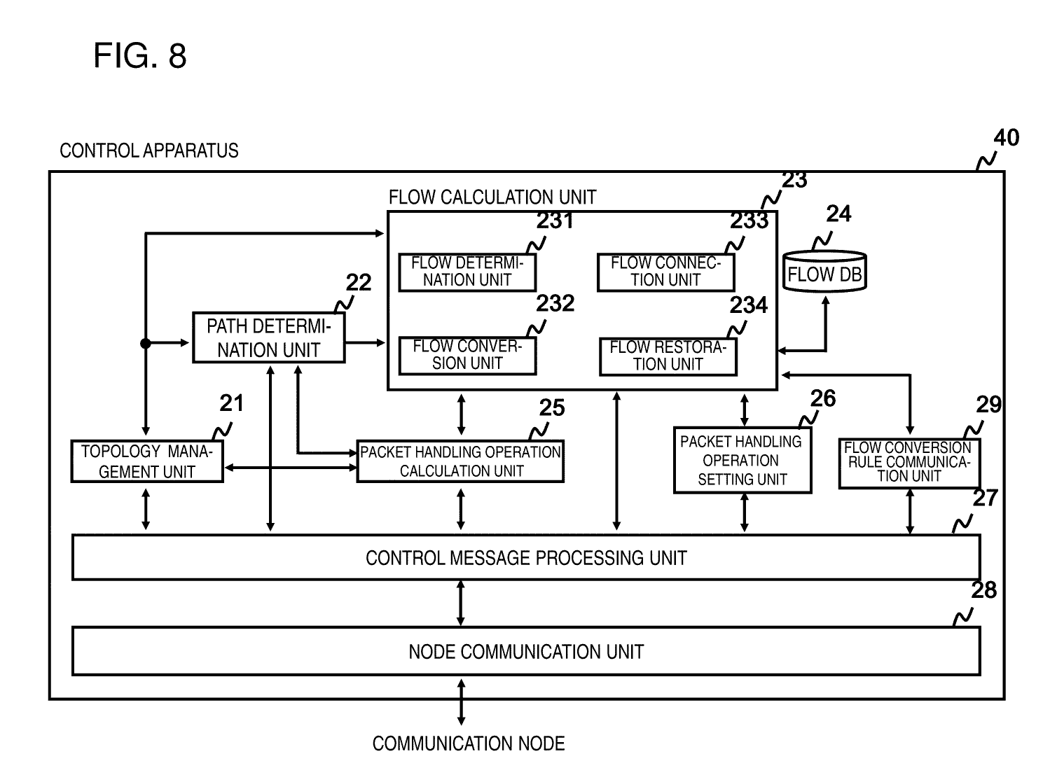

FIG. 8 illustrates an exemplary internal configuration of the control apparatus 40. The same components between FIGS. 8 and 3 are denoted by the same reference characters, and the description thereof will be omitted. The control apparatus 40 differs from the control apparatus 20 in that the control apparatus 40 includes a flow conversion rule communication unit 29 and the flow calculation unit 23 operates differently.

The flow conversion rule communication unit 29 is a means for notifying a control apparatus that controls another network of a flow conversion rule calculated by the flow calculation unit 23. The flow conversion rule communication unit 29 is also a means for receiving a flow conversion rule from another control apparatus. The flow conversion rule communication unit 29 communicates with another control apparatus 40 via communication nodes 10. Alternatively, the control apparatuses 40 may directly communicate with each other.

In addition to the functions described in the first exemplary embodiment, the flow calculation unit 23 has a function of calculating packet identification conditions so that packets whose header information has been rewritten in a neighboring network (packets processed by a flow conversion rule) can be forwarded in the control target network of the corresponding control apparatus 40. In addition, the flow calculation unit 23 has a function of recalculating, when another control apparatus is notified of a flow conversion rule and the flow calculation unit 23 receives a response (an error notification described below) indicating that the flow conversion rule has already been set in a communication node included in the control target network of the another control apparatus, the flow conversion rule.

Topology information collected and managed by the topology management unit 21 may be limited to topology information about the control target network of the control apparatus 40 or may be extended to topology information about the control target network of the another control apparatus. In addition, a packet forwarding path(s) determined by the path determination unit 22 may be limited to a packet forwarding path(s) within the control target network of the control apparatus 40 or may be extended to a packet forwarding path(s) over the control target network of the another control apparatus.

Next, an operation of the communication system according to the present exemplary embodiment will be described.

Hereinafter, the following operation of the communication system will be described on the basis of an example where a flow for forwarding a certain traffic from the terminal 30-1 to the terminal 40-4 in FIG. 7 has already been set and a flow for forwarding a traffic from the terminal 30-2 to the terminal 30-3, the flow having a feature similar to that of the certain traffic, is newly set. In addition, the flow from the terminal 30-1 to the terminal 30-4 will be referred to as a flow F03, and the flow from the terminal 30-2 to the terminal 30-3 will be referred to as a flow F04. In the communication nodes 10-2 to 10-5, the packet identification conditions in the respective flows are the same, as in the first exemplary embodiment.

In FIG. 7, a packet forwarding path used for forwarding packets from the terminal 30-1 to the terminal 30-4 includes the communication nodes 10-1 to 10-6. In addition, when receiving a packet, the communication node 10-6 outputs the packet to an interface connected to the terminal 30-4. A packet forwarding path used for forwarding packets from the terminal 30-2 to the terminal 30-3 includes the communication nodes 10-2 to 10-5. When receiving a packet, the communication node 10-5 outputs the packet to an interface connected to the terminal 30-3.

The flows F03 and F04 share some communication nodes included in these two packet forwarding paths. Namely, the communication nodes 10-1 to 10-5 are shared by the two packet forwarding paths. Since the same packet identification conditions are used in these communication nodes, the communication nodes 10-2 to 10-5 cannot distinguish the flows F03 and F04, whereby packets could be mixed with either one of the flows.

Among these communication nodes, in the communication nodes 10-2 and 10-3, a mixture of flows can be avoided by causing the control apparatus 40-1 to set a packet handling operation for identifying each of the similar flows from different input points and for performing appropriate forwarding in the communication node 10-2. More specifically, header information may be rewritten as described in the first exemplary embodiment. Alternatively, another method may be applied. Alternatively, for example, an encapsulation technique in which a different type of packet header is added to the top of the packet header when a packet is inputted to an individual network or a source routing technique in which information about a packet forwarding path that needs to be used for forwarding is embedded inside the packet header may be applied.

However, the link connecting the communication nodes 10-3 and 10-4 is a link connecting different networks, and the control apparatus 40-1 does not have the authority to set packet handling operations in the communication node 10-4.

Thus, the control apparatus 40-1 determines whether a set of packet identification conditions that has already been set in the communication node 10-3 collides with a set of packet identification conditions that is newly set. If any existing set of packet handling operations conflicts with the new set of packet identification conditions, setting the new flow causes a mixture of flows. In such case, the control apparatus 40-1 causes the communication node 10-3 to rewrite packet header information to perform flow conversion.

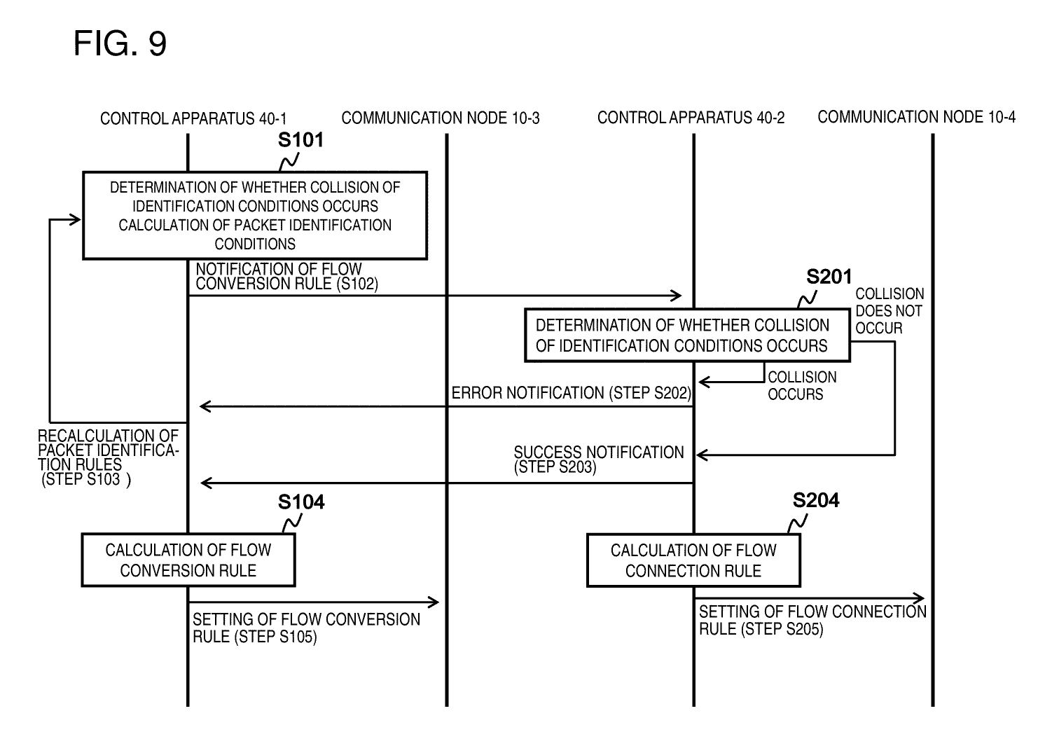

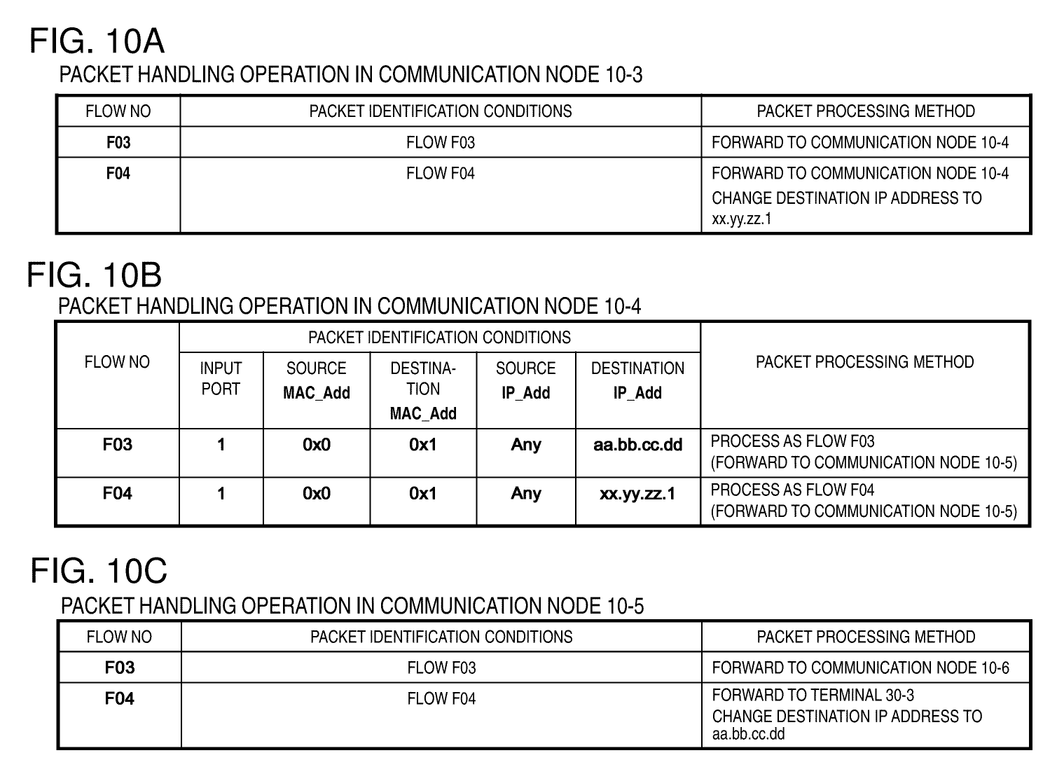

FIG. 9 is a sequence diagram illustrating an exemplary operation of the communication system according to the present exemplary embodiment. FIGS. 10A-10C illustrate exemplary packet handling operations that are set in the communication nodes 10-3 to 10-5. In this example, a case in which the control apparatuses 40-1 and 40-2 set packet handling operations that realize the flow F04 in the communication nodes 10-3 and 10-4, respectively, will be described. There are cases in which a packet identification condition corresponding to a flow conversion rule and a packet identification condition corresponding to a flow restoration rule differ per network. This is because each network may use a different method for performing flow control and the packet identification conditions differ accordingly. An internal of network is controlled by various methods. For example, there are a network in which a packet is identified by a VLAN tag, a network that adopts SourceFlow, a network in which packets are encapsulated, and a network in which OpenFlow is adopted for only edge communication nodes and MPLS is used for core communication nodes.

A collision of flow entries may be avoided by using the following method in which a value that is used for changing packet header information is referred to as a label. In this method, a control apparatus causes a communication node located at a border between networks to change packet header information by using an inter-network label and causes a communication node located inside a network to change packet header information by using an intra-network label. In such case, too, a set of packet identification conditions in a packet handling operation in a communication node located at an edge of a network are made different from a set of packet identification conditions in a packet handling operation in a communication node located inside a network.

In FIG. 10A, the packet identification conditions in the packet handling operation that is set by the control apparatus 40-1 in the communication node 10-3 and that realizes the flow F04 are represented as a flow F04. In FIG. 10C, the packet identification conditions in the packet handling operation that is set by the control apparatus 40-2 in the communication node 10-5 and that realizes the flow F04 is represented as a flow F04. Both sets of the packet identification conditions in the packet handling operations that realize the flow F04 illustrated in FIGS. 10A and 10C are represented by the same reference characters “flow F04.” However, as described above, a different network may use a different flow control method, and these sets of packet identification conditions may differ accordingly. Thus, the contents thereof may differ from each other.

As illustrated in FIG. 9, first, the control apparatus 40-1 acquires information about the flows that have already been set in the control target network of the control apparatus 40-1 from the flow DB 24. Next, as described in the first exemplary embodiment, the control apparatus 40-1 determines whether a new set of packet identification conditions collides with any existing set of previously set packet handling operations. If the control apparatus 40-1 determines that a collision of packet identification conditions occurs, the control apparatus 40-1 calculates packet identification conditions that avoid the collision of packet identification conditions (step S101).

Next, the control apparatus 40-1 notifies the control apparatus 40-2 that the calculated packet identification conditions and a flow conversion rule are to be set in a communication node included in the control target network 50 of the control apparatus 40-1 via the flow conversion rule communication unit 29 (step S102). Namely, the control apparatus 40-1 requests the control apparatus 40-2 to use the packet identification conditions as the packet identification conditions in the packet handling operation to be set in the communication node 10-4.

The control apparatus 40-2 determines whether the packet identification conditions calculated from the flow conversion rule supplied from the control apparatus 40-1 collide with any set of packet identification conditions that have already been set in the communication node 10-4 (step S201).

If the control apparatus 40-2 determines that a collision of packet identification conditions occurs, the control apparatus 40-2 transmits an error notification to the control apparatus 40-1 (step S202). If the control apparatus 40-2 determines that a collision of packet identification conditions does not occur, the control apparatus 40-2 transmits a success notification to the control apparatus 40-1 (step S203).

If the control apparatus 40-1 receives an error notification from the control apparatus 40-2, the control apparatus 40-1 recalculates the packet identification conditions (step S103) and notifies the control apparatus 40-2 of the recalculated packet identification conditions including a conversion rule (step S102).

If the control apparatus 40-1 receives a success notification from the control apparatus 40-2, the control apparatus 40-1 calculates a flow conversion rule that is set in the communication node 10-3 (step S104). Next, the control apparatus 40-1 sets the flow conversion rule in the communication node 10-3 (step S105). For example, as illustrated in FIG. 10A, the control apparatus 40-1 sets, in the communication node 10-3, a packet processing method for forwarding the packets that belong to the flow F04 to the communication node 10-4 and for rewriting header information.

If the set of packet identification conditions transmitted from the control apparatus 40-1 does not collide with any set of previously set packet identification conditions, the control apparatus 40-2 uses the packet identification conditions as the packet identification conditions that are set in the communication node 10-4 and calculates a flow connection rule (step S204). Next, the control apparatus 40-2 sets the flow connection rule in the communication node 10-4 (step S205). For example, as illustrated in FIG. 10B, in a packet identification condition corresponding to the flow F04, the destination IP address is set to xx.yy.zz.1.

In the communication node 10-4, since different packet identification conditions are set between the flows F03 and F04, the communication node 10-4 can handle these flows as being different. In addition, as described in the first exemplary embodiment, a flow restoration rule may be set in the communication node 10-4. In such case, when notifying the control apparatus 40-2 of the packet identification conditions calculated in step S101 (step S102) or at timing different from step S102, the control apparatus 40-1 notifies the control apparatus 40-2 of a value corresponding to the initial header information. However, as described above, the flow restoration rule may be set in another communication node other than the communication node 10-4. For example, as illustrated in FIG. 10C, the flow restoration rule may be set in the communication node 10-5. In this way, a communication node included in the network 51 or located at an edge of the network 51 can restore the header information. Alternatively, processing for restoring the header information may be performed in a network different from the networks 50 and 51.

In the present exemplary embodiment, a method for avoiding a collision of packet identification conditions at a border between networks has been described by using the method described in the first exemplary embodiment. However, the method described in the second exemplary embodiment may be used to avoid such a collision. Namely, an identifier that can uniquely identify a flow may be allocated, and the identifier may be used for calculating a flow conversion rule and a flow connection rule.

In addition, while a communication system has been described by illustrating two different networks 50 and 51 as an example in the present exemplary embodiment, the number of networks is not limited to two. The communication system may include three or more networks and a control apparatus that controls these networks. In such case, a physically single control apparatus could serve as the above control apparatuses 40-1 and 40-2. For example, the control apparatus 40-2 receives a flow conversion rule from the control apparatus 40-1, sets a packet handling operation(s) in a communication node(s) included in its own control target network 51, and notifies a control apparatus that controls another network of the flow conversion rule.

In addition, while a value used for calculating a flow conversion rule, a flow connection rule, and a flow restoration rule is determined through notifications between control apparatuses in the above example, another apparatus having an adjustment mechanism may separately be provided. In addition, notifications between control apparatuses or communications with an adjustment mechanism may be performed by causing nodes in data plane to perform communications. Alternatively, a management network may separately be provided.

In addition, instead of causing control apparatuses in neighboring networks to notify each other of a value used for calculating a flow conversion rule, a flow connection rule, and a flow restoration rule, a control apparatus in a certain network such as a control apparatus in a network that has received a packet first may be caused to determine such value and notify the other control apparatus of the value. For example, in FIG. 7, the control apparatus 40-1 may calculate the flow conversion rule, flow connection rule, or flow restoration rule that are set in the communication nodes 10-4 to 10-6 included in the control target network 51 of the control apparatus 40-2 and notify the control apparatus 40-2 of the corresponding value. Namely, the control apparatus 40-1 may notify the control apparatus 40-2 of a packet handling operation that is set in at least one of the plurality of communication nodes 10-1 to 10-6 included in the plurality of networks 50 and 51, the packet handling operation (a flow conversion rule and a flow restoration rule) being for changing packet header information and the packet handling operation (a flow connection rule) being for processing packets whose header information has been rewritten. In this way, a certain control apparatus (for example, the control apparatus 40-1) calculates a packet handling operation and notifies another control apparatus (for example, the control apparatus 40-2) of the calculated packet handling operation. Namely, the notifying control apparatus can control the packet handling operations used in the control apparatuses.

As described above, in the communication system according to the present exemplary embodiment, when traffics having similar features need to be controlled individually, control over networks can be achieved. The communication system according to the present exemplary embodiment, for example, is beneficial when a plurality of networks are virtually established on a common communication infrastructure that cover a plurality of bases and service environments are individually established on the virtual networks, particularly when a wide area cloud service is provided.

The above exemplary embodiments can partially or entirely be described but not limited to as follows.

### [Mode 1]

See the communication system according to the above first aspect.

### [Mode 2]

The communication system according to mode 1;
wherein an individual one of the plurality of communication nodes processes a received packet(s) on the basis of a packet handling operation(s) including a matching rule(s) against which header information of a packet(s) is matched; and
wherein, in response to setting the first packet handling operation for changing header information of the packet(s) in the first communication node, the control apparatus sets the second packet handling operation including the changed header information as a matching rule in the second communication node.

### [Mode 3]

The communication system according to mode 1 or 2;
wherein the first and second communication nodes are included on a
forwarding path of the packet(s); and
wherein the second communication node is a communication node serving as a next forwarding destination of the first communication node on the forwarding path.

### [Mode 4]

The communication system according to mode 3;
wherein the control apparatus sets a second packet handling operation for forwarding the packet(s) including the changed header information to the forwarding path in the second communication node.

### [Mode 5]

The communication system according to any one of modes 1 to 4;
wherein the control apparatus comprises:
a first setting unit (first setting means) that sets a first packet handling operation for changing header information of the packet(s) in the first communication node; and
a second setting unit (second setting means) that sets the second packet handling operation in the second communication node in response to that the first setting unit sets the first packet handling operation.

### [Mode 6]

The communication system according to any one of modes 1 to 5;
wherein the control apparatus sets a third packet handling operation for changing the changed header information included in the packet(s) back to initial header information in a third communication node.

### [Mode 7]

The communication system according to any one of modes 2 to 6;
wherein the control apparatus sets a packet handling operation for changing header information of the packet(s) to header information different from header information used as the matching rule in the first communication node, as the first packet handling operation.

### [Mode 8]

See the communication system according to the above second aspect.

### [Mode 9]

The communication system according to mode 8;
wherein an individual one of the plurality of communication nodes processes a received packet(s) on the basis of a packet handling operation(s) including a matching rule(s) against which header information of a packet(s) is matched; and
wherein, in response to that the first control apparatus sets the first packet handling operation, the second control apparatus sets the second packet handling operation including the changed header information as a matching rule in the second communication node.

### [Mode 10]

The communication system according to mode 8 or 9;
wherein the first communication node is located at an end of the first network and the second communication node is located at an end of the second network; and
wherein the first and second communication nodes are connected to each other.

### [Mode 11]

The communication system according to any one of modes 8 to 10, further comprising:
a setting apparatus comprising:
a first setting unit (first setting means) that causes the first control apparatus included in the first network to set the first packet handling operation in the first communication node; and
a second setting unit (second setting means) that causes the second control apparatus included in the second network to set the second packet handling operation in the second communication node.

### [Mode 12]

The communication system according to any one of modes 8 to 11;
wherein the second control apparatus sets a third packet handling operation for changing the changed header information included in the packet(s) back to initial header information in at least one communication node included in the second network.

### [Mode 13]

The communication system according to mode 12;
wherein the second control apparatus sets the third packet handling operation in a communication node that is included in the second network and that is connected to a third communication node included in a third network.

### [Mode 14]

The communication system according to mode 9;
wherein the first control apparatus sets a packet handling operation for changing header information of the packet(s) to header information different from header information used as the matching rule in the second network, as the first packet handling operation.

### [Mode 15]

The communication system according to any one of modes 8 to 14;
wherein the changed header information includes an identifier for uniquely identifying a flow to which the packet(s) belongs in the plurality of networks.

### [Mode 16]

The communication system according to any one of modes 8 to 15;
wherein the first control apparatus supplies a packet handling operation that is set in at least one of the plurality of communication nodes included in the plurality of networks, the packet handling operation being for changing header information of the packet(s), to a control apparatus that sets the packet handling operation in the communication node.

### [Mode 17]

The communication system according to any one of modes 8 to 16;
wherein the first control apparatus supplies a packet handling operation that is set in at least one of the plurality of communication nodes included in the plurality of networks, the packet handling operation being for processing the packet(s) including changed header information to a control apparatus that sets the packet handling operation in the communication node.

### [Mode 18]

The communication system according to any one of modes 8 to 17;
wherein the first control apparatus supplies a packet handling operation that is set at least one of the plurality of communication nodes included in the plurality of networks, the packet handling operation being for changing the changed header information included in the packet(s) back to initial header information to a control apparatus that sets the packet handling operation in the communication node.

### [Mode 19]

See the communication method according to the above third aspect.

### [Mode 20]

The communication method according to mode 19, further comprising a step of setting a third packet handling operation for changing the changed header information included in the packet(s) back to initial header information in a third communication node.

### [Mode 21]

See the control apparatus according to the above fourth aspect.

### [Mode 22]

The control apparatus according to mode 21;
wherein, when a first identification condition that is previously set in the second communication node and that is for identifying a packet(s) matches a second identification condition that is newly set in the second communication node and that is for identifying a packet(s), the control apparatus sets the first and second packet handling operations in the first and second communication nodes.

### [Mode 23]

The control apparatus according to mode 21 or 22;
wherein the control apparatus sets a third packet handling operation for changing the header information rewritten in accordance with the first packet handling operation back to initial header information in a communication node including the second communication node.

### [Mode 24]

The control apparatus according to any one of modes 21 to 23;
wherein the control apparatus notifies a control apparatus that controls a second network different from the first network of the header information rewritten in accordance with the first packet handling operation.

### [Mode 25]

See the control apparatus control method according to the above fifth aspect.

### [Mode 26]

The control apparatus control method according to mode 25, further comprising a step of:
determining whether a first identification condition that is previously set in the second communication node and that is for identifying a packet(s) matches a second identification condition that is newly set in the second communication node and that is for identifying a packet(s); and
wherein, if the first and second identification conditions match, the first and second packet handling operations are set in the first and second communication nodes.

### [Mode 27]

The control apparatus control method according to mode 25 or 26, further comprising a step of setting a third packet handling operation for changing the header information rewritten in accordance with the first packet handling operation back to initial header information in a communication node including the second communication node.

### [Mode 28]

The control apparatus control method according to any one of modes 25 to 27, further comprising a step of notifying a control apparatus that controls a second network different from the first network of the header information rewritten in accordance with the first packet handling operation.

### [Mode 29]

See the program according to the above sixth aspect.

### [Mode 30]

The program according to mode 29, causing the computer to perform processing for:
determining whether a first identification condition that is previously set in the second communication node and that is for identifying a packet(s) matches a second identification condition that is newly set in the second communication node and that is for identifying a packet(s);
wherein, if the first and second identification conditions match, the first and second packet handling operations are set in the first and second communication nodes.

### [Mode 31]

The program according to mode 29 or 30, causing the computer to perform processing for:
setting a third packet handling operation for changing the header information rewritten in accordance with the first packet handling operation back to initial header information in a communication node including the second communication node.

### [Mode 32]

The program according to any one of modes 29 to 31, causing the computer to perform processing for:
notifying a control apparatus that controls a second network different from the first network of the header information rewritten in accordance with the first packet handling operation.
The disclosure of each of the above PTLs is incorporated herein by reference thereto. Modifications and adjustments of the exemplary embodiments and the examples are possible within the scope of the overall disclosure (including the claims) of the present invention and based on the basic technical concept of the present invention. In addition, various combinations and selections of various disclosed elements (including the elements in each of the claims, exemplary embodiments, examples, drawings, etc.) are possible within the scope of the claims of the present invention. Namely, the present invention of course includes various variations and modifications that could be made by those skilled in the art according to the overall disclosure including the claims and the technical concept. In particular, the present description discloses numerical value ranges. However, even if the description does not particularly disclose arbitrary numerical values or small ranges included in the ranges, these values and ranges should be deemed to have been specifically disclosed.

### REFERENCE SIGNS LIST

10, 10-1 to 10-6, 100-1, 100-2 communication node
20, 20a, 40, 40-1, 40-2, 101 control apparatus
21 topology management unit
22 path determination unit
23 flow calculation unit
24 flow database (DB)
25 packet handling operation calculation unit
26 packet handling operation setting unit
27 control message processing unit
28 node communication unit
29 flow conversion rule communication unit
30-1 to 30-4 terminal
50, 51 network
231 flow determination unit
232 flow conversion unit
233 flow connection unit
234 flow restoration unit

What is claimed is:

1. A communication system, comprising:
a plurality of communication nodes that process received packets on the basis of a packet handling operation for processing packets; and
a control apparatus that sets the packet handling operation in the plurality of communication nodes;
wherein, in response to setting a first packet handling operation for changing header information of a packet(s) in a first communication node, the control apparatus sets a second packet handling operation for processing the packet(s) including the changed header information in a second communication node.

2. The communication system according to claim 1;
wherein an individual one of the plurality of communication nodes processes a received packet(s) on the basis of a packet handling operation(s) including a matching rule(s) against which header information of a packet(s) is matched; and
wherein, in response to setting the first packet handling operation for changing header information of the packet(s) in the first communication node, the control apparatus sets the second packet handling operation including the changed header information as a matching rule in the second communication node.

3. The communication system according to claim 1;
wherein the first and second communication nodes are included on a forwarding path of the packet(s); and
wherein the second communication node is a communication node serving as a next forwarding destination of the first communication node on the forwarding path.

4. The communication system according to claim 3;
wherein the control apparatus sets a second packet handling operation for forwarding the packet(s) including the changed header information to the forwarding path in the second communication node.

5. The communication system according to of claim 1;
wherein the control apparatus comprises:
a first setting unit that sets a first packet handling operation for changing header information of the packet(s) in the first communication node; and
a second setting unit that sets the second packet handling operation in the second communication node in response to that the first setting unit sets the first packet handling operation.

6. The communication system according to claim 1;
wherein the control apparatus sets a third packet handling operation for changing the changed header information included in the packet(s) back to initial header information in a third communication node.

7. The communication system according to claim 2;
wherein the control apparatus sets a packet handling operation for changing header information of the packet(s) to header information different from header information used as the matching rule in the first communication node, as the first packet handling operation.

8. A communication system, comprising:
a plurality of networks that include a plurality of control apparatuses that set packet handling operations for processing packets in a plurality of communication nodes;
wherein a first control apparatus included in a first network sets a first packet handling operation for changing header information of a packet(s) in a first communication node included in the first network; and
wherein in response to that the first control apparatus sets the first packet handling operation, a second control apparatus included in a second network sets a second packet handling operation for processing the packet(s) including the changed header information in a second communication node included in the second network.

9. The communication system according to claim 8;
wherein an individual one of the plurality of communication nodes processes a received packet(s) on the basis of a packet handling operation(s) including a matching rule(s) against which header information of a packet(s) is matched; and
wherein, in response to that the first control apparatus sets the first packet handling operation, the second control apparatus sets the second packet handling operation including the changed header information as a matching rule in the second communication node.

10. The communication system according to claim 8;
wherein the first communication node is located at an end of the first network and the second communication node is located at an end of the second network; and
wherein the first and second communication nodes are connected to each other.

11. The communication system according to claim 8, further comprising:
a setting apparatus comprising:
a first setting unit that causes the first control apparatus included in the first network to set the first packet handling operation in the first communication node; and
a second setting unit that causes the second control apparatus included in the second network to set the second packet handling operation in the second communication node.

12. The communication system according to claims 8;
wherein the second control apparatus sets a third packet handling operation for changing the changed header information included in the packet(s) back to initial header information in at least one communication node included in the second network.

13. The communication system according to claim 12;
wherein the second control apparatus sets the third packet handling operation in a communication node that is included in the second network and that is connected to a third communication node included in a third network.

14. The communication system according to claim 9;
wherein the first control apparatus sets a packet handling operation for changing header information of the packet(s) to header information different from header information used as the matching rule in the second network, as the first packet handling operation.

15. The communication system according to claim 8;
wherein the changed header information includes an identifier for uniquely identifying a flow to which the packet(s) belongs in the plurality of networks.

16. The communication system according to claim 8;
wherein the first control apparatus supplies a packet handling operation that is set in at least one of the plurality of communication nodes included in the plurality of networks, the packet handling operation being for changing header information of the packet(s), to a control apparatus that sets the packet handling operation in the communication node.

17. The communication system according to claim 8;
wherein the first control apparatus supplies a packet handling operation that is set in at least one of the plurality of communication nodes included in the plurality of networks, the packet handling operation being for processing the packet(s) including changed header information to a control apparatus that sets the packet handling operation in the communication node.

18. The communication system according to claim 8;
wherein the first control apparatus supplies a packet handling operation that is set at least one of the plurality of communication nodes included in the plurality of networks, the packet handling operation being for changing the changed header information included in the packet(s) back to initial header information to a control apparatus that sets the packet handling operation in the communication node.

19. A communication method for a communication system including a plurality of communication nodes that process received packets on the basis of a packet handling operation for processing packets, the communication method comprising:
setting a first packet handling operation for changing header information of a packet(s) in a first communication node; and
setting a second packet handling operation for processing the packet(s) including the changed header information in a second communication node in response to that the first packet handling operation is set.

20. The communication method according to claim 19, further comprising setting a third packet handling operation for changing the changed header information included in the packet(s) back to initial header information in a third communication node.

21. A control apparatus, controlling a first network in which a packet(s) is forwarded from a first communication node to a second communication node;
wherein the control apparatus sets a first packet handling operation for causing the first communication node to rewrite header information of a packet(s) received thereby in the first communication node; and
wherein the control apparatus sets a second packet handling operation for causing the second communication node to process the packet(s) including the rewritten header information in the second communication node.

22. The control apparatus according to claim 21;
wherein, when a first identification condition that is previously set in the second communication node and that is for identifying a packet(s) matches a second identification condition that is newly set in the second communication node and that is for identifying a packet(s), the control apparatus sets the first and second packet handling operations in the first and second communication nodes.

23. The control apparatus according to claim 21;
wherein the control apparatus sets a third packet handling operation for changing the header information rewritten in accordance with the first packet handling operation back to initial header information in a communication node including the second communication node.

24. The control apparatus according to claim 21;
wherein the control apparatus notifies a control apparatus that controls a second network different from the first network of the header information rewritten in accordance with the first packet handling operation.

25. A control apparatus control method for controlling a control apparatus that controls a first network in which a packet(s) is forwarded from a first communication node to a second communication node, the control apparatus control method comprising:
setting a first packet handling operation for causing the first communication node to rewrite header information of a packet(s) received thereby in the first communication node; and
setting a second packet handling operation for causing the second communication node to process the packet(s) including the rewritten header information in the second communication node.

26. The control apparatus control method according to claim 25, further comprising a step of:
determining whether a first identification condition that is previously set in the second communication node and that is for identifying a packet(s) matches a second identification condition that is newly set in the second communication node and that is for identifying a packet(s); and
wherein, if the first and second identification conditions match, the first and second packet handling operations are set in the first and second communication nodes.

27. The control apparatus control method according to claim 25, further comprising setting a third packet handling operation for changing the header information rewritten in accordance with the first packet handling operation back to initial header information in a communication node including the second communication node.

28. The control apparatus control method according to claim 25, further comprising a step of notifying a control apparatus that controls a second network different from the first network of the header information rewritten in accordance with the first packet handling operation.

29. A non-transitory computer-readable recording medium storing a program, causing a computer that controls a control apparatus that controls a first network in which a packet(s) is forwarded from a first communication node to a second communication node to perform processing for:
setting a first packet handling operation for causing the first communication node to rewrite header information of a packet(s) received thereby in the first communication node; and
setting a second packet handling operation for causing the second communication node to process the packet(s) including the rewritten header information in the second communication node.

30. The medium according to claim 29, causing the computer to perform processing for:
determining whether a first identification condition that is previously set in the second communication node and that is for identifying a packet(s) matches a second identification condition that is newly set in the second communication node and that is for identifying a packet(s);
wherein, if the first and second identification conditions match, the first and second packet handling operations are set in the first and second communication nodes.

31. The medium according to claim 29, causing the computer to perform processing for:
setting a third packet handling operation for changing the header information rewritten in accordance with the first packet handling operation back to initial header information in a communication node including the second communication node.

32. The medium according to claim 29, causing the computer to perform processing for:
notifying a control apparatus that controls a second network different from the first network of the header information rewritten in accordance with the first packet handling operation.
